(19) United States
(12) Patent Application Publication
(10) Pub. No.: US 2011/0117448 A1
(43) Pub. Date: May 19, 2011

(54) NON-AQUEOUS ELECTROLYTE SECONDARY BATTERY

(76) Inventors: Takao Inoue, Aichi (JP); Masahisa Fujimoto, Osaka (JP)

(21) Appl. No.: 11/883,807

(22) PCT Filed: Jan. 20, 2006
(86) PCT No.: PCT/JP2006/300882

§ 371 Date: May 22, 2008

(30) Foreign Application Priority Data
Feb. 7, 2005 (JP) 2005-030894

(51) Int. Cl. H01M 10/056

(52) U.S. Cl. 429/338; 429/207; 429/341; 429/342; 429/343; 429/339

(57) ABSTRACT

An object of the invention is to provide an inexpensive non-aqueous electrolyte secondary battery that allows reversible charge and discharge to be carried out. The non-aqueous electrolyte secondary battery according to the invention includes a positive electrode, a negative electrode containing carbon capable of storing and releasing potassium, and a non-aqueous electrolyte including potassium ions.

### TECHNICAL FIELD

The present invention relates to a non-aqueous electrolyte secondary battery including a positive electrode, a negative electrode, and a non-aqueous electrolyte.

### BACKGROUND ART

Today, non-aqueous electrolyte secondary batteries are in wide use as secondary batteries with high energy density, in which lithium ions for example are transferred between a positive electrode and a negative electrode to carry out charge and discharge.

In such a non-aqueous electrolyte secondary battery in general, a composite oxide of a lithium transition metal having a layered structure of lithium nickel oxide (LiNiO₂), lithium cobalt oxide (LiCoO₂) or the like is used as the positive electrode, and a carbon material capable of storing and releasing lithium, a lithium metal, a lithium alloy, or the like is used as the negative electrode (see, for example, Patent Document 1).

The non-aqueous electrolyte produced by dissolving an electrolyte salt such as lithium tetrafluoroborate (LiBF₄) or lithium hexafluorophosphate (LiPF₆) in an organic solvent such as ethylene carbonate or diethyl carbonate is used.

Meanwhile, researches concerning non-aqueous electrolyte secondary batteries using potassium ions instead of lithium ions have recently been started. The negative electrode of the non-aqueous electrolyte secondary battery includes a metal containing potassium. There are abundant supplies of potassium from seawater, and therefore the use of potassium can reduce the cost.

[Patent Document 1] JP 2003-151549 A

### DISCLOSURE OF THE INVENTION

### Problems to be Solved by the Invention

The charge and discharge reaction of the conventional non-aqueous electrolyte secondary battery is carried out by dissolution and precipitation of potassium ions and therefore a good charge/discharge efficiency and a good charge/discharge characteristic are not obtained.

Repetition of charge and discharge process causes a branch-like precipitate (dendrite) to be more easily generated in the non-aqueous electrolyte. The dendrite may cause internal short-circuiting, and sufficient safety cannot be secured.

It is an object of the invention to provide an inexpensive non-aqueous electrolyte secondary battery that allows reversible charge and discharge to be carried out.

### Means for Solving the Problems

(1)

A non-aqueous electrolyte secondary battery according to one aspect of the invention includes a positive electrode, a negative electrode including carbon capable of storing and releasing potassium, and a non-aqueous electrolyte containing potassium ions.

In the non-aqueous electrolyte secondary battery according to the invention, potassium ions are reversibly stored in and released from the negative electrode containing carbon. Therefore, reversible charge and discharge can be carried out.

Furthermore, since no dendrite is produced, improved safety is secured. The use of potassium that is available in abundance as a resource can reduce the cost.

(2)

The negative electrode may further include a collector including a metal foil, and the carbon may be applied on the collector. In this way, potassium ions are more easily stored and released reversely in and from the negative electrode containing the carbon.

(3)

The carbon may include graphite. In this way, a high energy density can be obtained.

(4)

The non-aqueous electrolyte may include potassium hexafluorophosphate. In this way, improved safety can be obtained.

(5)

The non-aqueous electrolyte may include one or more selected from the group consisting of a cyclic carbonate, a chain carbonate, esters, cyclic ethers, chain ethers, nitriles, and amides. In this way, the cost can be reduced and the safety can be improved.

### Effects of the Invention

According to the invention, reversible charge and discharge can be carried out. Since no dendrite is produced, improved safety is secured. The use of potassium that is available in abundance as a resource can reduce the cost.

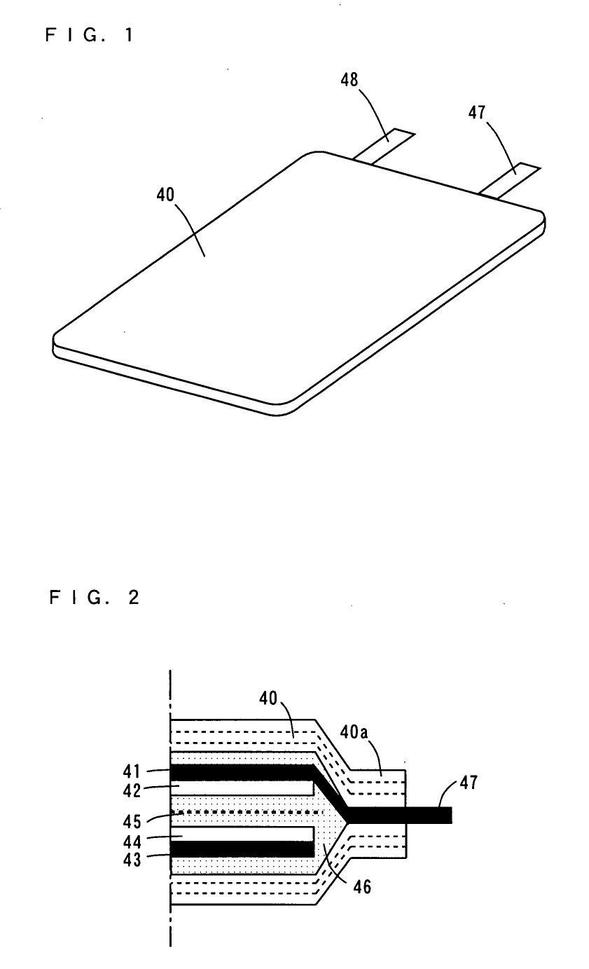

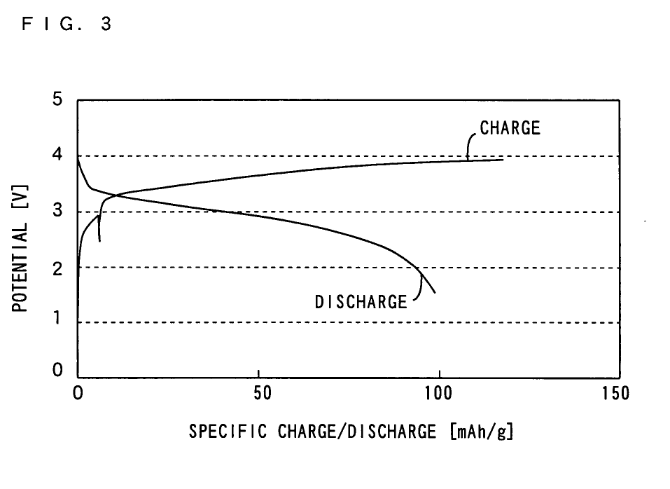

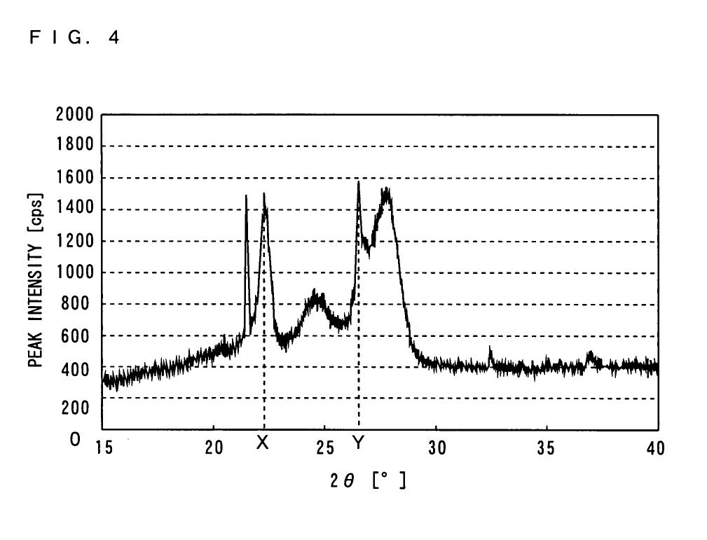

### BRIEF DESCRIPTION OF THE DRAWINGS

[FIG. 1] FIG. 1 is a perspective view of a non-aqueous electrolyte secondary battery according to an embodiment.

[FIG. 2] FIG. 2 is a schematic sectional view of the non-aqueous electrolyte secondary battery shown in FIG. 1.

[FIG. 3] FIG. 3 is a graph showing the charge/discharge characteristic of the non-aqueous electrolyte secondary battery.

[FIG. 4] FIG. 4 is a graph showing a result of XRD measurement according to the embodiment.

### BEST MODE FOR CARRYING OUT THE INVENTION

In the following paragraphs, a non-aqueous electrolyte secondary battery according to an embodiment will be described in conjunction with the accompanying drawings.

The non-aqueous electrolyte secondary battery according to the embodiment includes a positive electrode, a negative electrode, and a non-aqueous electrolyte.

Note that the materials, and the thickness, the concentrations and the like of the materials are not limited to those in the following description and may be set as required.

<Manufacture of Positive Electrode>

A material (hereinafter referred to as “positive electrode material”) containing for example 85 parts by weight of potassium manganese oxide powder as a positive electrode active material, 10 parts by weight of Ketjenblack, carbon black powder serving as a conductive agent, and 5 parts by weight of polyvinylidene fluoride as a binder is prepared.

The positive electrode material is for example mixed to a 10% N-methylpyrrolidone solution by weight to the positive electrode material, and slurry as a positive electrode mixture is produced.

Then, the slurry is for example applied by a doctor blade method on a 3-by-3 cm region of an aluminum foil as thick as 18 μm for example as a positive electrode collector, then dried and formed into a positive electrode active material layer.

Then, a positive electrode tab is attached on a region of the aluminum foil where the positive electrode active material layer is not formed to form a positive electrode.

Note that instead of the polyvinylidene fluoride, the binder in the positive electrode material may be at least one selected from polytetrafluoroethylene, polyethylene oxide, polyvinyl acetate, polymethacrylate, polyacrylate, polyacrylonitrile, polyvinyl alcohol, styrene-butadiene rubber, carboxymethylcellulose, and the like.

If the amount of the binder is excessive, the ratio of the positive electrode active material contained in the positive electrode material is reduced, and therefore a high energy density cannot be obtained. Therefore, the amount of the binder is from 0% to 30% by weight relative to the entire positive electrode material, preferably from 0% to 20% by weight, more preferably from 0% to 10% by weight.

Instead of the Ketjenblack as the conductive agent contained in the positive electrode material, other carbon materials such as acetylene black and graphite may be used. Note that if the content of the conductive agent is too small, the conductivity of the positive electrode material cannot be sufficiently improved, while if the amount of the agent is excessive, the ratio of the positive electrode active material contained in the positive electrode material is reduced, and a high energy density cannot be obtained. Therefore, the amount of the conductive agent is from 0% to 30% by weight relative to the entire positive electrode material, preferably from 0% to 20% by weight, more preferably from 0% to 10% by weight.

As the positive electrode collector, a material such as foamed aluminum and foamed nickel may be used to improve the electronic conductivity.

<Manufacture of Negative Electrode>

A negative electrode active material containing a substance such as carbon capable of storing and releasing potassium and polyvinylidene fluoride (PVDF) as a binder are added so that the ratio of these materials is 95:5 and then mixed in order to produce slurry as a negative electrode mixture.

An example of the carbon contained in the negative electrode active material may include graphite. According to the embodiment, the spacing d (002) of the graphite is from 3.354 Å to 3.370 Å and the crystallite diameter Lc is at least 150 Å.

Then, for example, N-methyl-2-pyrrolidone is added to the negative electrode mixture, followed by mixing and kneading, so that the slurry is produced.

Then, the slurry is applied by a doctor blade method to both surfaces of a copper foil as thick as 20 μm for example that serves as a negative collector, so that a negative electrode active material layer is formed.

Then, the collector having the negative electrode active material layer formed thereon is cut into a 2.0-by-2.0 cm piece, and a negative electrode tab is attached to the piece, so that a negative electrode is produced.

<Manufacture of Non-Aqueous Electrolyte>

A non-aqueous electrolyte produced by dissolving an electrolyte salt in a non-aqueous solvent may be used.

Examples of the non-aqueous solvent may include a cyclic carbonate, a chain carbonate, esters, cyclic ethers, chain ethers, nitriles, amides, and a combination thereof, which are typically used as a non-aqueous solvent for a battery.

Examples of the cyclic carbonate may include ethylene carbonate, propylene carbonate, butylene carbonate, and any of the above having its hydrogen group partly or entirely fluorinated such as trifluoropropylene carbonate and fluoroethyl carbonate.

Examples of the chain carbonate may include dimethyl carbonate, ethyl methyl carbonate, diethyl carbonate, methyl propyl carbonate, ethyl propyl carbonate, methyl isopropyl carbonate, and any of the above having its hydrogen group partly or entirely fluorinated.

Examples of the esters may include methyl acetate, ethyl acetate, propyl acetate, methyl propionate, ethyl propionate, and γ-butyrolactone. Examples of the cyclic ethers may include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and a crown ether.

Examples of the chain ethers may include 1,2-dimethoxyethane, diethyl ether, dipropyl ether, diisopropyl ether, dibutyl ether, dihexyl ether, ethyl vinyl ether, butyl vinyl ether, methylphenyl ether, ethylphenyl ether, butylphenyl ether, pentylphenyl ether, methoxytoluene, benzylethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, trienthylene glycol dimethyl ether, and tetraethylene glycol dimethyl.

An example of the nitriles may include acetonitrile, and an example of the amides may include dimethylformamide.

Examples of the electrolyte salt may include substances excluding peroxides with high safety that are soluble to a non-aqueous solvent such as potassium hexafluorophosphate (KPF₆), potassium fluoroborate (KBF₄), KCF₃SO₃, and KBeTi. Note that one of the above electrolyte salts may be used or two or more of the above may be combined for use.

According to the embodiment, the non-aqueous electrolyte is produced by adding potassium hexafluorophosphate as the electrolyte salt in a concentration of 0.7 mol/l to a non-aqueous solvent produced by mixing ethylene carbonate and diethyl carbonate in the ratio of 50:50 by volume.

<Manufacture of Non-aqueous Electrolyte Secondary Battery>

FIG. 1 is a perspective view of a non-aqueous electrolyte secondary battery according to the embodiment.

As shown in FIG. 1, the non-aqueous electrolyte secondary battery according to the embodiment includes a case body 40 and a negative electrode tab 47 and a positive electrode tab 48 are extended externally from the inside of the case body 40.

FIG. 2 is a schematic sectional view of the non-aqueous electrolyte secondary battery shown in FIG. 1. The case body 40 is made of a laminated film for example of aluminum.

As shown in FIG. 2, a negative electrode collector 41 and a positive electrode collector 43 are provided in the case body 40.

A negative electrode active material layer 42 including carbon is formed on the negative electrode collector 41, and a positive electrode active material layer 44 is formed on the positive electrode collector 43.

The negative electrode active material layer 42 formed on the negative electrode collector 41 and the positive electrode active material layer 44 formed on the positive electrode collector 43 are provided to be opposite to each other through a separator 45.

A non-aqueous electrolyte 46 is injected in the case body 40. At the end of the side of the case body 40 from which the negative electrode tab 47 and the positive electrode tab 48 are extended, a sealed opening 40a sealed by welding is formed.

The negative electrode tab 47 connected to the negative electrode collector 41 is externally extended through the sealed opening 40a. Although not shown in FIG. 2, the positive electrode tab 48 connected to the positive electrode collector 43 is also externally extended through the sealed opening 40a in the same manner as the negative electrode tab 47.

In the non-aqueous electrolyte secondary battery according to the embodiment, potassium ions are reversibly stored in and released from the negative electrode containing carbon. In this way, reversible charge and discharge can be carried out. Therefore, a good charge/discharge efficiency and a good charge/discharge characteristic can be expected.

Since no dendrite is produced, improved safety is secured. The use of potassium that is available in abundance as a resource allows an inexpensive non-aqueous electrolyte secondary battery to be provided.

### EXAMPLE

<Charge-Discharge Test and Evaluation Thereof>

As in the following paragraphs, the charge/discharge characteristic of a non-aqueous electrolyte secondary battery produced according to the embodiment was examined.

FIG. 3 is a graph showing the charge/discharge characteristic of the non-aqueous electrolyte secondary battery.

In the non-aqueous electrolyte secondary battery described above, charge was carried out until the specific charge capacity per gram of the negative electrode active material reached about 120 mAh/g with a constant current of 0.7 mA, and discharge was carried out until the discharge cutoff voltage was 1.5 V with a constant current of 0.7 mA.

It was found as the result of the charge-discharge test described above that the specific discharge capacity per gram of the negative electrode active material was about 100 mAh/g and good charge and discharge was performed. More specifically, it was found that potassium ions were reversibly stored and released in and from the positive electrode. In this way, the advantage of the new non-aqueous electrolyte secondary battery over the conventional non-aqueous electrolyte secondary battery using lithium ions was recognized.

<XRD Measurement and Evaluation Thereof>

The non-aqueous electrolyte secondary battery in a charged state was disassembled, and the negative electrode active material layer 42 containing carbon was measured by XRD (x-ray diffractometer).

FIG. 4 is a graph showing the result of XRD measurement in the example. Note that the XRD measurement was carried out while the negative electrode active material layer 42 was placed in a plastic bag and the plastic bag was sealed so that the negative electrode active material layer 42 was not in contact with the air.

In FIG. 4, the X-ray peaks when the angle of diffraction 2θ was X (=22.3°) and Y (=26.5°) were attributable to the carbon contained in the negative electrode active material layer 42.

More specifically, the peak when the angle of diffraction 2θ equaled X corresponded to the case in which potassium ions were inserted in the negative electrode, and the spacing d(002) of carbon in the case was about 3.9 Å.

The peak when the angle of diffraction 2θ equaled Y corresponded to the case in which potassium ions were not inserted in the negative electrode, and the spacing d(002) of carbon in the case was about 3.35 Å. Note that the peaks when the angle of diffraction 2θ was about 21.5°, 24.4°, and 27.9° were attributable to the plastic bag described above.

It was found as the result of the XRD measurement described above that potassium ions were surely stored in the negative electrode containing carbon.

### INDUSTRIAL APPLICABILITY

The non-aqueous electrolyte secondary battery according to the invention may be applied as various kinds of power supplies such as a portable power supply and an automotive power supply.

1. A non-aqueous electrolyte secondary battery comprising a positive electrode, a negative electrode including carbon capable of storing and releasing potassium, and a non-aqueous electrolyte including potassium ions.

2. The non-aqueous electrolyte secondary battery according to claim 1, wherein said negative electrode includes a collector including a metal foil, and
said carbon is applied on said collector.

3. The non-aqueous electrolyte secondary battery according to claim 1, wherein said carbon includes graphite.

4. The non-aqueous electrolyte secondary battery according to claim 1, wherein said non-aqueous electrolyte includes potassium hexafluorophosphate.

5. The non-aqueous electrolyte secondary battery according to claim 1, wherein said non-aqueous electrolyte includes one or more selected from the group consisting of a cyclic carbonate, a chain carbonate, esters, cyclic ethers, chain ethers, nitriles, and amides.
